(19) United States
(12) Patent Application Publication
(10) Pub. No.: US 2014/0374360 A1
(43) Pub. Date: Dec. 25, 2014

(54) METHOD FOR SEPARATING SUSPENSION OR COLLOID COMPONENTS AND A DEVICE FOR SEPARATING SUSPENSION OR COLLOID COMPONENTS

(71) Applicant: Fraunhofer-Gesellschaft Zur Forderung Der Angewandten Forschung E.V., Munchen (DE)

(72) Inventors: Manuel Kemmler, Freiburg (DE); Oliver Poppe, Penzberg (DE)

(21) Appl. No.: 14/368,896

(22) PCT Filed: Dec. 21, 2012
(86) PCT No.: PCT/EP2012/076717

§ 371 Date: Jun. 26, 2014

(30) Foreign Application Priority Data
Dec. 29, 2011 (DE) 10 2011 122 579.3

(51) Int. Cl. B01D 21/01

(52) U.S. Cl. CPC B01D 21/01
USPC 210/702; 210/198.1

(57) ABSTRACT

By means of a method and a device for separating suspension or colloid components a sample is moved through a conduit system which extends in axial direction at at least one flow rate in at least one flow direction over a time period until reaching axial separation of components which are then separated from each other.

### CROSS-REFERENCE TO RELATED APPLICATION

This application is a U.S. National Phase Patent Application based on International Application No. PCT/EP2012/076717 filed Dec. 21, 2012, the entire disclosure of which is hereby explicitly incorporated by reference herein.

### BACKGROUND OF THE INVENTION

1. Field of the Invention

The invention relates to a method for separating suspension or colloid components, in particular blood constituents.

The invention further relates to a device for separating suspension or colloid components, in particular blood constituents.

2. Description of the Related Art

WO 96/31270 A1 discloses a method and a device for whole blood separation wherein agglutinins are used to improve separation.

DE 103 05 050 A1 discloses a test element and a method for blood analyses wherein a microfluidic channel system is used for the flow transport of the blood sample and wherein liquid components are extracted from the blood sample. The flow transport is controlled by valve elements. A reaction chamber is provided for agglutination.

EP 2 413 138 A2 discloses a device and a method for separating blood components, mainly destined to separate blood cells. For that purpose, a microfluidic device is used which has a separation unit, preferably in form of a membrane or another filter element. Before being supplied to the separation unit, the liquid sample is pre-treated with an agglutination agent, which provokes the agglutination of blood cells.

DE 103 52 535 A1 discloses a method and a device for separating blood plasma and white blood cells from the remaining blood or from cellular blood components. For this purpose, a microstructural separation unit with separation areas is provided. The transportation path is formed by a channel system having capillary dimensions, through which the liquid flows in one direction from an inlet to a collection section. Agglutinating substances are added to form complexes allowing separating specific particles from the suspension. The liquid, or the parts separated from the liquid, are transported by capillary action and/or a comparable force. The transport of larger particles is slowed down by the arrangement of the geometric systems in the transport path.

The scientific paper “High flow rate microfluidic device for blood plasma separation using a range of temperatures” by A. I. Rodriguez-Villarreal, M. Arundell, M. Carmona et al., Lab Chip 2010, 10, 211-219 discloses a method and a device for separating blood components based on a lateral separation of blood particles having passed a constrictor channel in a conduit system. The percentage of plasma retained with this method is around 4 percent.

The scientific paper “Passive microfluidic devices for plasma extraction from whole human blood” by E. Sollier, H. Rostaining, P. Pouteau et al., Sensors and Actuators B 141 (2009) 617-624 discloses three methods and devices for separating blood components. These methods are based on microfiltration and centrifugation in microfluidic apparatus. The best one of the methods presented is the so-called “corner edge” design providing for a dilution of whole blood by factor 20. The yield is smaller than 11 percent.

The requirements for the separation concern the duration of the process, the quantity of blood components extracted, the amount of dead volume, automatic handling with few, if any, manual actions, low manufacturing costs, variable sample volumes, overall size and robustness.

### SUMMARY OF THE INVENTION

The present invention provides a method and a device for the separation of components in suspensions or colloids into residual particle components and further processed particle components, which with a relatively simple conduit system distinguishes itself by an efficient separation of the components of a relatively small and variable sample volume in a relatively short time with low dead volumes.

The fact that according to the invention the separation of suspension or colloid components such as, in particular, blood components from a sample containing agglutinated components is done by a purely axial flow in the conduit system until the axial separation of agglutinated components and the remaining colloids or suspension is set, results in a relatively simple structure of the conduit system allowing efficient separation with relatively small sample sizes.

The presented invention uses so-called agglutinins, as disclosed in WO 96/31270. In medical terminology agglutination (lat.: agglutinare: to glue to) means sticking or clumping together of, for example, cells or anti-bodies and anti-genes. The agglutination can be increased by adding substances such as the cationic polymer hexadimethrin bromide, resulting in a faster separation process in the presented invention.

Samples can be, for example, whole blood, urine, saliva or culture medium. Agglutinated components are, for example, blood cells, microorganisms or viruses.

Examples of application are the separation of whole blood as a suspension with anticoagulant into plasma and blood cells, the separation of whole blood or suspension without anticoagulant into serum and blood cells. The conduit system has diameters in the millimeter range for sample volumes in the upper microliter range, in order to ensure a certain axial length of the sample in the channel. Samples of too small size cannot be separated efficiently.

For this reason, conduit system diameters in the micrometer range are preferably used for separating samples of test persons having only low sample volumes, such as infants. In order to minimize the conduit length and the resulting space requirement, diameters in the centimeter range are preferred for samples in the milliliter range. For the separation of whole blood, urine, saliva and culture medium components, the conduit system is placed separately in a fluidic chip for reasons of hygiene.

The system is largely closed, ensuring a low risk of contamination for the user of the device. For a particularly cost-effective implementation of the system, the hose solution is preferred. The hose solution is also preferred for the separation of lower risk material.

In one form thereof, the present invention provides a method for separating components of a suspension or colloid, in particular blood components, including the steps of adding a reagent (18) to the suspension or the colloid (16) for agglutinating the components to a sample (11), and moving the sample (11) with the agglutinated components in a conduit system (8), which extends in an axial direction, at a flow rate and in a flow direction over a time period until reaching axial separation of the agglutinated components from the remaining sample (13, 14).

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic view of the first example of embodiment of the invention and includes a conduit system formed by a non-branching duct;

FIG. 2 is a schematic view of the conduit of the example of embodiment according to FIG. 1 during several steps of carrying out the method according to the invention;

FIG. 3 shows a schematic representation of another example of embodiment of a device according to the invention with the conduit system configured as a fluidic chip;

FIG. 4 is the plan view of the fluidic chip after being filled with inert fluid and a sample containing agglutinated blood cells for an exemplary embodiment according to FIG. 3;

FIG. 5 is a plan view of the fluidic chip according to the exemplary embodiment of FIG. 4 after moving the sample in a first direction of flow at a first flow rate over a first time period; and

FIG. 6 a plan view of the fluidic chip according to FIG. 4 after moving the sample in a second direction of flow opposite to the first one at a second flow rate differing from the first flow rate over a second time period.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

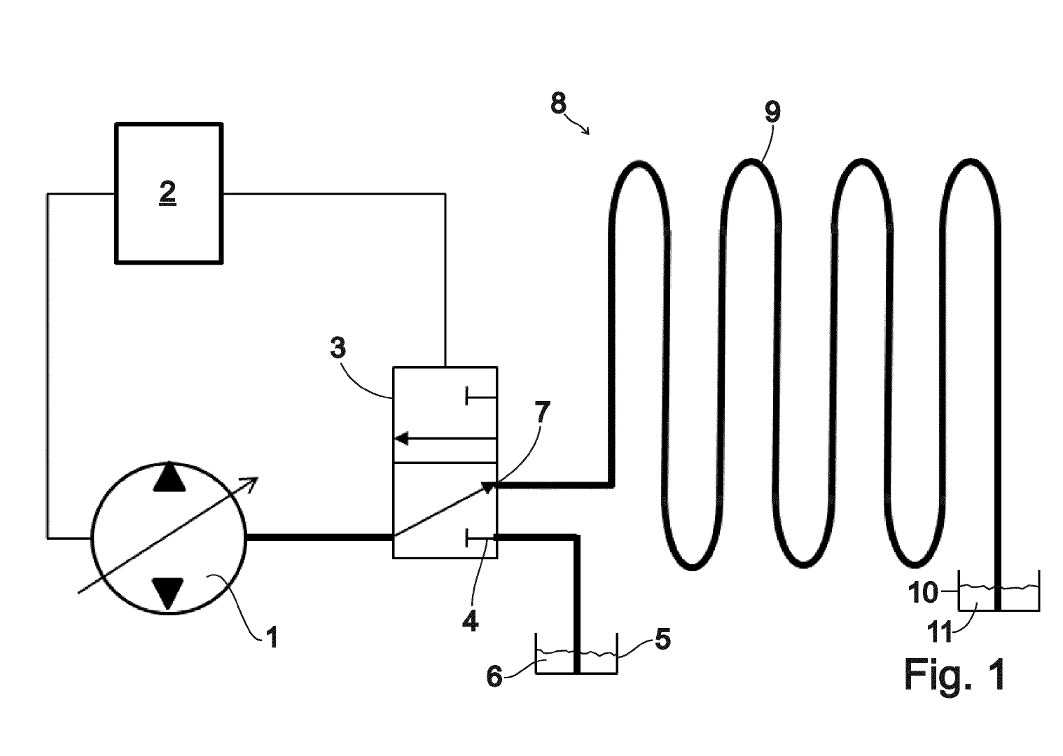

FIG. 1 is a schematic representation of a first exemplary embodiment of a device according to the invention for separating in particular blood components. The embodiment of FIG. 1 has a pumping unit 1 that is controllable by means of a control unit 2 for pumping in two pumping directions each with adjustable pumping power. Furthermore, the embodiment according to FIG. 1 is provided with a two-way valve unit 3 as valve unit, fluid-dynamically connected with an inert fluid container 5 via an inert fluid connection 4. The inert fluid container 5 contains a stock of inert fluid 6, as shown in the representation according to FIG. 1. The storage solution 6 serves the purpose of supplying an inert fluid to the pumping unit 1 in order to act hydraulically and not pneumatically.

Further, the two-way valve unit 3 is equipped with a conduit connection 7 to which a conduit system 8 is connected in the exemplary embodiment according to FIG. 1 in the form of a non-branching conduit 9 free of obstacles and perforation, extending in axial direction over a length with a cross-section remaining constant, at least in sections, preferably over the whole length, of, for example, 1.5 mm in diameter for a circular cross-section.

The conduit 9 is conveniently coiled or formed as spiral to the largest possible extent with a small footprint in the axial direction.

The end of conduit 9 opposite to conduit connection 7 is connected with a storage/collecting receptacle assembly 10, here consisting of a collecting container and a storage container, which, as shown in FIG. 1, has the function of a storage container for a sample 11 pre-mixed with a reagent for agglutination of blood cells, on one hand, and, on the other, the function of a collecting container for holding blood components, as explained in more detail below. For the agglutination of blood cells, for instance, phytohemagglutinin (PHA-E), which belongs to the so-called lectins, is used as a reagent.

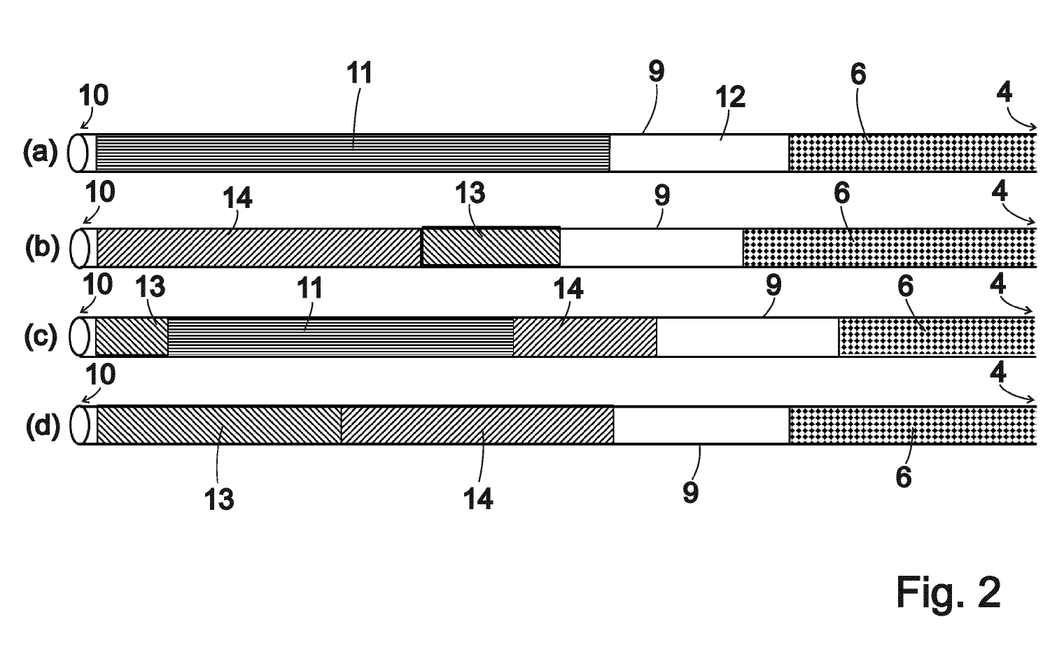

FIG. 2 shows different partial images (a), (b), (c) and (d) of conduit 9 for the exemplary embodiment 1 after performing several steps of the method according to the invention. In the upper partial image (a) in FIG. 2, conduit 9 is filled with inert fluid 6 at the end facing inert fluid connection 4. At the end facing the storage/collecting receptacle assembly 10 the sample 11 with a volume of agglutinated blood cells of, for example, 200 micro liters, is introduced by interaction of the pump unit 1, control unit 2 and the two-way valve unit 3, taking up an air-cushion 12 from the now used storage container of the storage/collecting receptacle assembly 10. Behind and in front of the sample 11 is the air-cushion 12.

After pumping in inert fluid 6, pumping back the collected inert fluid 6 entraining the air cushion 12 and then collecting the sample 11 until setting the first separation of blood components according to the first partial image (b) of FIG. 2 with a very low flow rate, a first preparation of plasma 13 is available adjacent to the air cushion 12 at the end of conduit 9 opposite to the storage/collecting receptacle assembly 10, while a mixed volume 14 enriched with agglutinated blood cells is available at the end facing the storage/collecting receptacle assembly 10.

After a relatively short first pumping break which enhances the agglutination of components by sedimentation, on the basis of the arrangement according to the first partial image (b), the first pumping interval continuously pumps in direction of the inert fluid connection 4 as a first flow direction in this embodiment at a relatively high first flow rate over a first time period until the air cushion 12 is located near inert fluid connection 4. After completion of this first pumping operation the plasma 13, as shown in the lower middle partial image (c), is now available at the end of conduit 9 facing the storage/collecting receptacle assembly 10.

Then, after another pumping break, the disposition of the amount of plasma 13 already enriched in volume compared to partial image (b) and compared to the amount of mixed volume 14 enriched with agglutinated blood cells is pumped back in direction of the storage/collecting receptacle assembly 10 as second flow direction in a second pumping cycle over a second time period at a lower second flow rate compared to the first flow rate until, as shown in the lowest partial image (d), plasma 13 with a now relatively high volume adjoins the end of conduit 9 facing the storage/collecting receptacle assembly 10. The separation of blood components is now completed after a typical processing time of around 15 minutes with a yield of plasma of typically between about 30 percent and about 40 percent, and, by continuously pumping at a withdrawal rate, plasma 13 can now be extracted from conduit 9 to the storage/collecting receptacle assembly 10 now used with the collecting container for subsequent processing.

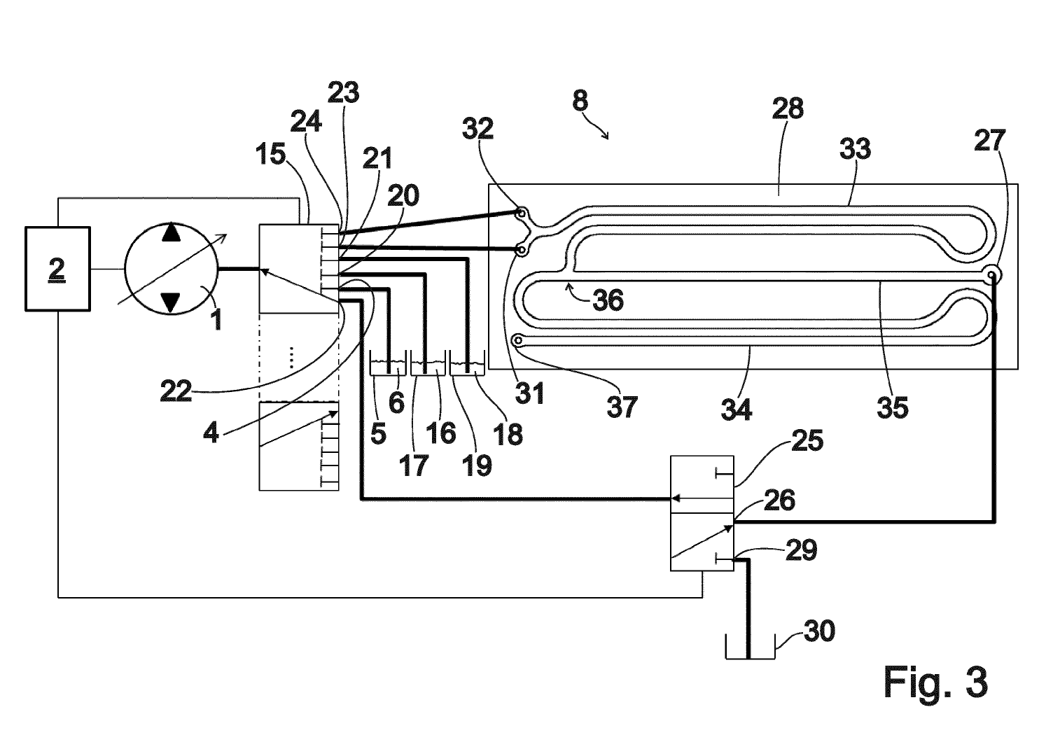

FIG. 3 shows a schematic representation of another exemplary embodiment of a device according to the invention, here for the separation of blood components, wherein the elements identical in the embodiment according to FIG. 1 and in the embodiment according to FIG. 2 are marked with the same reference numbers and in part not explained in detail again in the following. The embodiment according to FIG. 3 has a multi-way valve unit 15 as valve unit to which, in addition to the inert fluid container 5 filled with inert fluid 6, a storage container 17 of a storage receptacle assembly filled with pure whole blood 16 as suspension or colloid, optionally treated with an anticoagulant, and another storage container 19 receiving an agglutinating reagent 18 for the agglutination of blood cells are connected fluid dynamically by means of supply connections 20, 21, respectively.

Furthermore, the multi-way valve unit 15 is provided with a first outlet 22, a second outlet 23 and a third outlet 24. Inert fluid 6 can be supplied from the inert fluid container 5, a multi-functional connection 27 of a fluidic chip 28, in which the conduit system 8 is built, via the first outlet 22, via a two-way valve unit 25, also controllable by control unit 2, and via the outlet 26 of the two-way valve unit 25. In addition, the two-way valve unit 25 is connected to a collecting container 30 via another outlet 29, which can be used to collect separated blood components, as explained more in detail below.

The second outlet 23 is connected to the storage container 17 collecting the whole blood 16, if multi-way valve unit 15 is set to the respective position, and is connected to a first supply connection 31 of the fluidic chip 28. The third outlet 24 of the multi-way valve unit 15, finally, is connected to the storage container 19 collecting the agglutinating reagent 18, if the multi-way valve unit 15 is set to the appropriate position.

The rectangular shaped fluidic chip 28 which is conveniently designed as a plastic injection molded part intended for single use, has a Y-type, cover closed conduit system 8 with an inlet section 33, a blind section 34 and an outlet section 35, interconnected in a connection area 36. The inlet section 33 is provided with the supply connections 31, 32 at the end opposite to the connection area, whereas the outlet section 35 is equipped with the multi-functional connection 27 at the end opposite to connection area 36. At its end opposite to the connection area 36, the blind section 34, to reduce the risk of contamination, is connected to a blind connection 37, which is penetrable only by gaseous and not by liquid fluid. The diameter of sections 33, 34, 35, for instance, is around 1.3 millimeters. The long side of the fluidic chip 28, for instance, is around 75 millimeters long and the short side, for instance, 25 millimeters, resulting in a length of approximately 140 millimeters each for the inlet section 33 and the blind section 34.

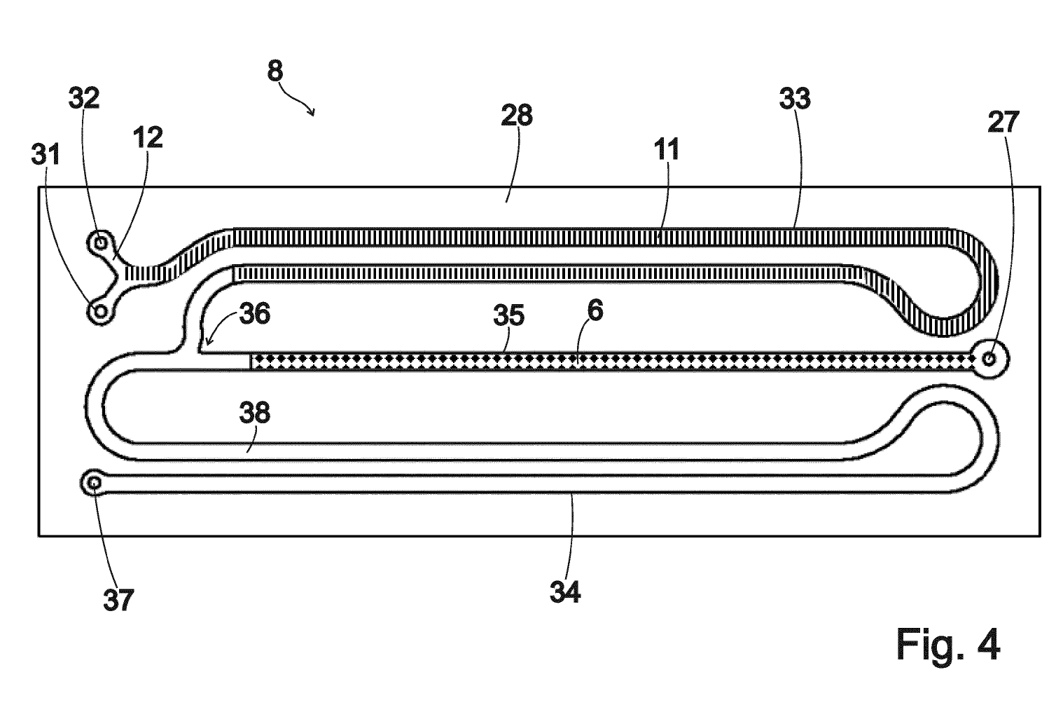

FIG. 4 shows the fluidic chip 28 of the embodiment according to FIG. 3 after pumping inert fluid 6 in the outlet 35 until close to the connection area 36 and to a sample 11 which contains agglutinated blood cells, as a result of by actuating the two-way valve unit 25 fluid dynamically separating the multi-functional connection 27 after pumping whole blood 16 and agglutinating reagent 18 previously made available at the supply connections 31, 32 into inlet section 33 while mixing. After introduction of sample 11 containing agglutinated blood cells, inlet section 33, which includes an air cushion 12, is connected to the inert fluid container 5 by correspondingly actuating the multi-way valve unit 15. The areas of inlet section 33 and outlet section 34 around the connection area 36 and the blind section 34 are filled with residual air 38.

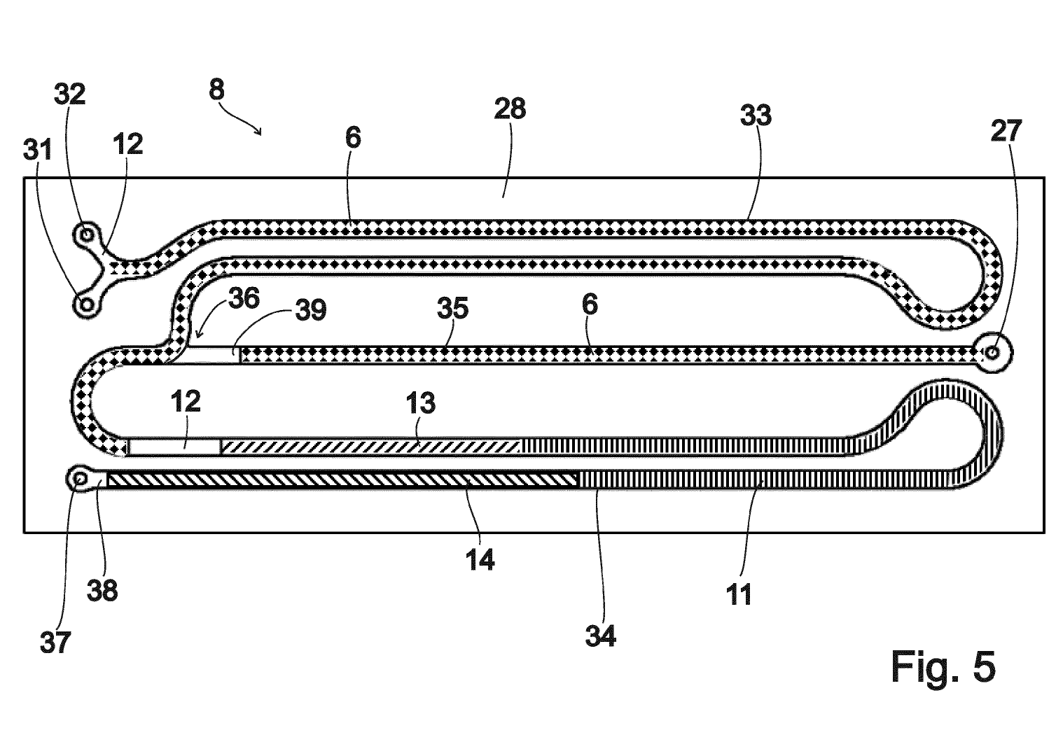

FIG. 5 shows the fluidic chip 28 of the embodiment according to FIG. 3 after moving the sample 11 of the arrangement according to FIG. 4 over a first time period at a first flow rate into a first flow direction from the inlet section 33 to the blind section 34. The sample 11 being separated into a volume predominantly containing plasma 13 and a mixed volume 14 is pumped into the blind section 34, followed by the air cushion 12 and inert fluid 6, until the mixed volume 14 gets close to the blind connection 37 while expelling residual air. The residual air forming another air cushion 39 and the inert fluid 6 already present in the outlet section 35 ensure that the sample 11 exclusively gets into the blind section 34.

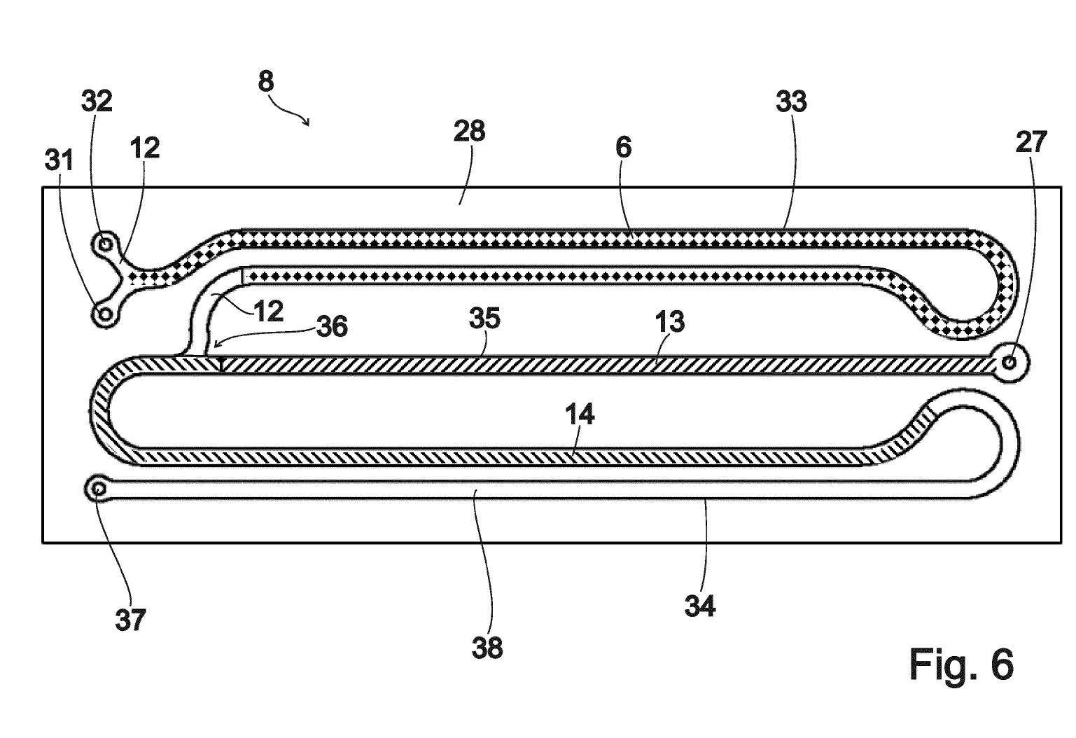

FIG. 6 shows the fluidic chip 28 on the basis of the arrangement according to FIG. 5 where after a processing time of typically around 9 minutes having actuated the multi-way valve unit 15 and the pumping unit 1 accordingly over a second time period in a second flow direction opposite to the first flow direction at a second flow rate differing from the first flow rate, which, in this embodiment, is lower than the first flow rate, with the outlets 23, 24 connected to the supply connections 31, 32 closed and after suction of the inert fluid 6 available at the outlet section 35, the volume at the outlet section 35 now contains plasma 13 with the inert fluid 6 available in the inlet section 33 together with the air cushion 12 in the connection area 36 forming a fluid dynamic block. The plasma 13 available with a yield of about 40 percent can now be transferred from the outlet section 35 via the multi-functional connection 27 to the collecting container 30 by accordingly setting the two-way valve unit 25 using control unit 2.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-8. (canceled)

9. A method for separating components of a suspension or colloid, comprising the steps of:
adding a reagent to the suspension or colloid for agglutinating the components to a sample;
moving the sample with the agglutinated components in a conduit system, which extends in an axial direction, at a first flow rate and in a first flow direction over a time period until reaching axial separation of the agglutinated components from the remaining sample.

10. The method of claim 9, further comprising the additional step, following said moving step, of moving the sample in a second flow direction opposite to the first flow direction at a second flow rate different from the first flow rate over another time period.

11. The method of claim 9, wherein the suspension or colloid is selected from the group consisting of whole blood, urine, saliva and culture medium.

12. The method of claim 9, wherein the agglutinated components are selected from the group consisting of blood cells, microorganisms and viruses.

13. A device for separating suspension or colloid components according to the method of claim 9, comprising:
a pumping unit;
a conduit system connected to the pumping unit;
a storage receptacle assembly for storing a suspension or a colloid;
a reagent for agglutinating suspension or colloid components or a sample with agglutinated components;
an inert fluid container for storing an inert fluid;
a collecting container for collating suspension or colloid components;
a valve unit selectively connecting the storage/collecting receptacle assembly and the inert fluid container with the conduit system; and
a control unit for controlling the valve unit and the pumping unit such that after sequentially introducing the inert fluid and the sample in the conduit system the sample flows through the conduit system at a flow rate in a flow direction.

14. The device of claim 13, wherein the conduit system is formed by a non-branching conduit with a constant section.

15. The device of claim 13, further comprising:
the conduit system connected in Y-type form with a blind section each connected with the inlet section and to an outlet section;
the outlet section coupleable to the collecting container at an end thereof opposite to the inlet section;
an air-permeable closure available at an end of the blind section facing away from the inlet section; and
the storage containers, the inert fluid container, the valve unit and the pumping unit connected to the end of the inlet section facing away from the blind section or the outlet, respectively.

16. The device according to one of the claim 13, wherein the pumping unit is configured to generate another flow direction opposite to the flow direction, with the other flow rate prevailing in the other flow direction being adjustable to differ from the flow rate.

17. The method of claim 10, wherein the suspension or colloid is selected from the group consisting of whole blood, urine, saliva and culture medium.

18. The method of claim 10, wherein the agglutinated components are selected from the group consisting of blood cells, microorganisms and viruses.

19. The method of claim 11, wherein the agglutinated components are selected from the group consisting of blood cells, microorganisms and viruses.

20. A device for separating suspension or colloid components according to the method of claim 10, comprising:
a pumping unit;
a conduit system connected to the pumping unit;
a storage receptacle assembly for storing a suspension or a colloid;
a reagent for agglutinating suspension or colloid components or a sample with agglutinated components;
an inert fluid container for storing an inert fluid;
a collecting container for collating suspension or colloid components;
a valve unit selectively connecting the storage/collecting receptacle assembly and the inert fluid container with the conduit system; and
a control unit for controlling the valve unit and the pumping unit such that after introducing the inert fluid first and then the sample in the conduit system the sample flows through the conduit system at a flow rate in a flow direction.

21. The device of claim 20, wherein the conduit system is formed by a non-branching conduit with a constant section.

22. The device of claim 20, further comprising:
the conduit system connected in Y-type form with a blind section each connected with the inlet section and to an outlet section;
the outlet section coupleable to the collecting container at an end thereof opposite to the inlet section;
an air-permeable closure available at an end of the blind section facing away from the inlet section; and
the storage containers, the inert fluid container, the valve unit and the pumping unit connected to the end of the inlet section facing away from the blind section or the outlet, respectively.

23. The device according to one of the claim 14, wherein the pumping unit is configured to generate another flow direction opposite to the flow direction, with the other flow rate prevailing in the other flow direction being adjustable to differ from the flow rate.

24. The device according to one of the claim 15, wherein the pumping unit is configured to generate generating another flow direction opposite to the flow direction, with the other flow rate prevailing in the other flow direction being adjustable to differ from the flow rate.

25. The device according to one of the claim 20, wherein the pumping unit is configured to generate another flow direction opposite to the flow direction, with the other flow rate prevailing in the other flow direction being adjustable to differ from the flow rate.

26. The device according to one of the claim 21, wherein the pumping unit is configured to generate another flow direction opposite to the flow direction, with the other flow rate prevailing in the other flow direction being adjustable to differ from the flow rate.

27. The device according to one of the claim 22, wherein the pumping unit is configured to generate another flow direction opposite to the flow direction, with the other flow rate prevailing in the other flow direction being adjustable to differ from the flow rate.
